(19) United States
(12) Patent Application Publication
(10) Pub. No.: US 2013/0159478 A1
(43) Pub. Date: Jun. 20, 2013

(54) METHOD AND APPARATUS FOR REDUCED POWER CONSUMPTION

(71) Applicants: Seppo Rousu, Oulu (FI); Antti Immonen, Helsinki (FI)

(72) Inventors: Seppo Rousu, Oulu (FI); Antti Immonen, Helsinki (FI)

(73) Assignee: RENESAS MOBILE CORPORATION, Tokyo (JP)

(21) Appl. No.: 13/327,269

(22) Filed: Dec. 15, 2011

(30) Foreign Application Priority Data
Dec. 14, 2011 (GB) 1121433.5

(51) Int. Cl. G06F 15/177

(52) U.S. Cl. 709/221

(57) ABSTRACT

A method, apparatus and computer program product are provided in order to dynamically select a network configuration that results in reduced power consumption by the mobile terminal. In this regard, a method is provided that includes characterizing an upcoming communication, wherein the characterization comprises at least one of transmission or reception. The method further includes determining a proposed network configuration based on a determined power consumption level of one or more network configurations available in a geographical area and the characterization of the upcoming communication. The method also includes causing the preferred configuration to be transmitted to a network entity.

### TECHNOLOGICAL FIELD

Embodiments of the present invention relate generally to communications technology and, more particularly, to reduced power consumption in mobile terminals.

### BACKGROUND

Mobile terminals by definition are powered by mobile power sources such as batteries, solar cells, calvanic and/or inductive chargers, universal serial bus (USB) power, network power supplies and/or the like. These power sources are under incredible pressures to be small and portable while still providing power sufficient to enable long periods of uninterrupted operation by a mobile terminal. However, as packet data consumption rates and multitasking increases along with the increased capabilities of mobile terminals, there is an increased drain on current power sources. Further complicating the problem is the historical trend of power sources lagging behind other mobile terminal hardware advancement and innovation (e.g. processors, peripheral devices form factor, display and/or the like).

### BRIEF SUMMARY

A method, apparatus and computer program product are therefore provided according to some example embodiments in order to dynamically select a network configuration that results in reduced power consumption by one or more mobile terminals. In particular the example systems and methods described herein are configured to evaluate various network conditions (e.g. frequency bands, data class, MIMO class, radio link latency, bandwidth, number of resource blocks, number of receivers, number of transmitters, number of sub carriers, modulations, carrier aggregation combinations, network data load, running applications, multiple concurrent radio communications, alternate radio access technology and/or the like) for potential effects on power consumption. Based on a characterization (e.g. transmission, reception or the like) of an upcoming communication and according to available frequency bands, in some example embodiments, a network configuration with a reduced power consumption rate may be selected. The proposed network configuration may be transmitted to an access point, network entity and/or an alternate apparatus (e.g. another mobile terminal, connected vehicle and/or the like) so that the upcoming communication may be transmitted on the proposed network configuration.

In one embodiment, a method is provided that comprises characterizing an upcoming communication. In some example embodiments, the characterization comprises at least one of transmission or reception. The method of this embodiment may also include determining a proposed network configuration based on a determined power consumption level of one or more network configurations available in a geographical area and the characterization of the upcoming communication. The method of this embodiment may also include causing the preferred configuration to be transmitted to a network entity.

In another embodiment, an apparatus is provided that includes at least one processor and at least one memory including computer program code with the at least one memory and the computer program code being configured, with the at least one processor, to cause the apparatus to at least characterize an upcoming communication. In some example embodiments, the characterization comprises one or more transmissions or receptions. The at least one memory and computer program code may also be configured to, with the at least one processor, cause the apparatus to determine a proposed network configuration based on a determined power consumption level of one or more network configurations available in a geographical area and the characterization of the upcoming communication. The at least one memory and computer program code may also be configured to, with the at least one processor, cause the apparatus to cause the preferred configuration to be transmitted to a network entity.

In the further embodiment, a computer program product may be provided that includes at least one non-transitory computer-readable storage medium having computer-readable program instruction stored therein with the computer-readable program instructions including program instructions configured to characterize an upcoming communication. In some example embodiments, the characterization comprises at least one of transmission or reception. The computer-readable program instructions may also include program instructions configured to determine a proposed network configuration based on a determined power consumption level of one or more network configurations available in a geographical area and the characterization of the upcoming communication. The computer-readable program instructions may also include program instructions configured to cause the preferred configuration to be transmitted to a network entity.

In yet another embodiment, an apparatus is provided that includes means for characterizing an upcoming communication. In some example embodiments, the characterization comprises one or more transmissions or receptions. The apparatus of this embodiment may also include means for determining a proposed network configuration based on a determined power consumption level of one or more network configurations available in a geographical area and the characterization of the upcoming communication. The apparatus of this embodiment may also include means for causing the preferred configuration to be transmitted to a network entity.

### DETAILED DESCRIPTION

Having thus described the example embodiments of the invention in general terms, reference will now be made to the accompanying drawings, which are not necessarily drawn to scale, and wherein:

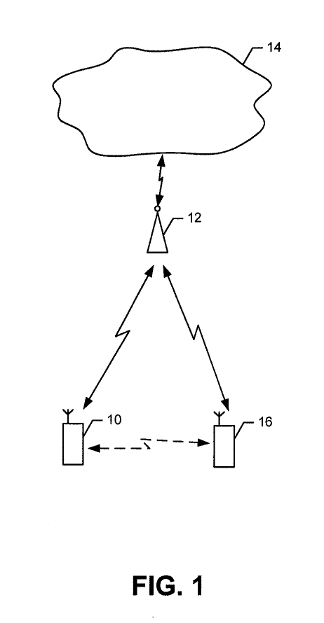

FIG. 1 is a schematic representation of a system having a mobile terminal that may benefit from some example embodiments of the present invention;

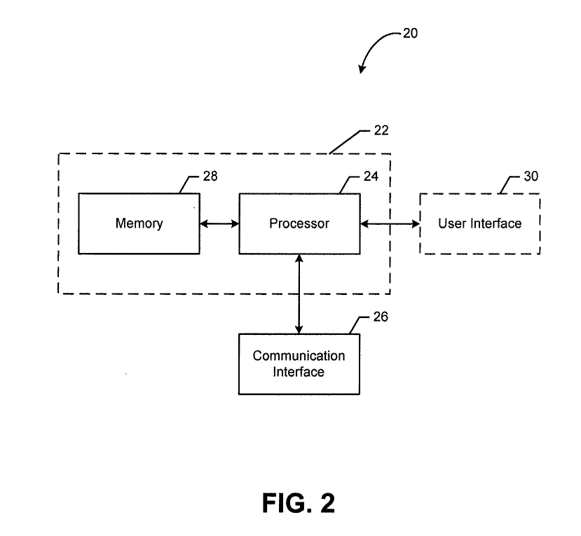

FIG. 2 is a block diagram of an apparatus that may be embodied by a mobile terminal in accordance with some example embodiments of the present invention;

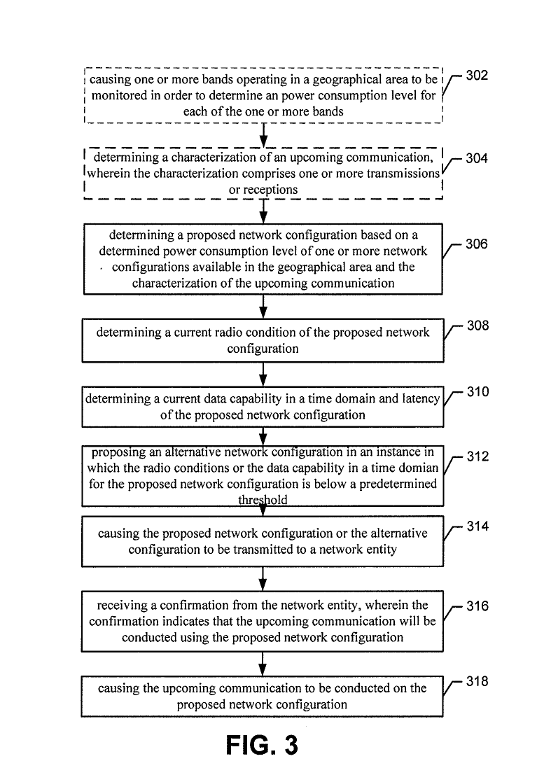

FIG. 3 is an example flow chart illustrating reduced power consumption operations performed by a mobile terminal in accordance with some example embodiments of the present invention; and

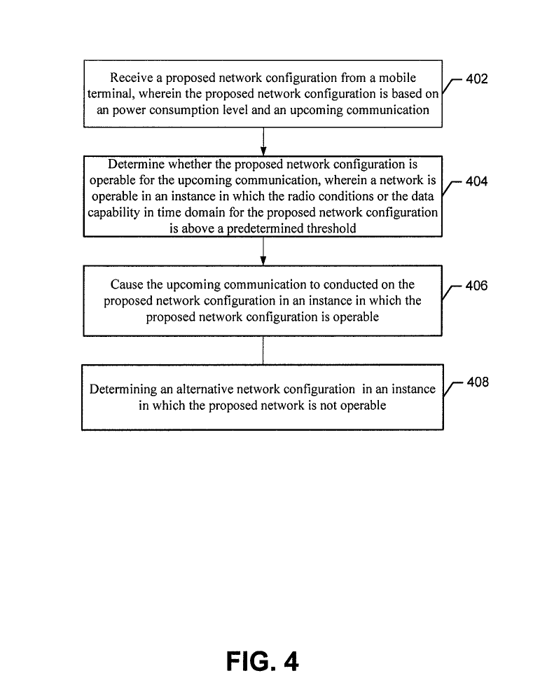

FIG. 4 is an example flow chart illustrating reduced power consumption operations performed by an access point in accordance with some example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a radio front end (including antenna(s), a radio transceiver, a radio transceiver integrated circuit), a baseband integrated circuit or application specific integrated circuit for a mobile phone or a similar integrated circuit in server, a cellular network device, or other network device.

In some example embodiments power consumption for a mobile terminal depends on, for example, signaling load with an apparatus or a network entity, such as an access point. The signaling load may be caused by multiple running applications, modules, processes or the like (e.g. a browser, file transfer, electronic mail, sport scores application, positioning, entertainment, capturing video/pictures, display(s), audio and/or the like) that are configured to cause a transmission and/or reception. Additionally these same applications, modules, processes or the like that may cause signaling overhead may also be consuming power by simply operating or executing in the background on the mobile terminal. Other features such as multitasking, and/or hardware such as the processor, the memory, the camera, other sensors and/or the like may also contribute to power consumption rates. Other potential mobile terminal power consumption may depend on network configurations such as active radio communication systems parameters; mode, band, channel, band width, resource blocks, modulation, number of carriers in uplink (UL)/downlink (DL), carrier aggregation combinations, transmission power and/or the like. Data communication load, latency, activity in a time domain and communication signal power in UL and DL via mobile terminal location and mobility may also contribute to power consumption. Power consumption differences between different network configurations may be caused by, but not limited to, one or more of: antenna efficiency, antenna voltage standing wave ratio (VSWR), own interference(s), external interferences, RF front end loss(es), downlink power level(s), uplink power level(s), communication distance, fading conditions, communication frequency(s), uplink data processing in analog domain, downlink data processing in analog domain, uplink data processing in digital domain, downlink data processing in digital domain.

In some example embodiments, machine to machine (M2M), device to device (D2D), vehicle to vehicle (V2V), vehicle to device (V2D), vehicle to roadside (V2R). vehicle to infrastructure (V2I) and/or the like devices that are configured for machine type communications (MTC), such as a mobile terminal, may be configured according to the systems and methods described herein to minimize power consumption. Alternatively or additionally, such example methods and systems may also apply to conventional communications devices.

In some example embodiments, the example method, apparatus and computer program product may be configured to minimize, reduce or otherwise decrease power consumption per communications bit with respect to a mobile terminal. In particular, the example mobile terminal may determine a network configuration (e.g. band, data class, multiple input multiple output (MIMO) class, latency, day, time period or the like) that yields the lowest power consumption. In some example embodiments communication may be shifted in time domain to the future, which provides lower power consumption and/or may be lower payload cost. In particular the mobile terminal may analyze bandwidth and data-class with respect to digital baseband power consumption, bandwidth and data-class (e.g. sampling rate) with respect to radio frequency integrated circuit (RFIC) power consumption and how a selected frequency band(s) (CA combination) affects radio frequency front end losses. The mobile terminal may then request (e.g. via User Equipment-Evolved Universal Terrestrial Radio Access (UE-EUTRA) capability, UECapabilityInformation message or the like) that another communications device, such as an access point, network entity or the like operate using the network configuration with the lowest power consumption for an upcoming communication.

In some example embodiments, additional signaling may be added to the UE-EUTRA-Capability and/or UECapabilityInformation message, that includes but is not limited to:

```
RF-Parameters ::= SEQUENCE {
  supportedBandListEUTRA SupportedBandListEUTRA
  supportedBandWidhtsEUTRA supportedBandWidhtsEUTRA
BandParameters-r10 ::= SEQUENCE {
  bandEUTRA-r10 INTEGER (1..64),
  bandParametersUL-r10 BandParametersUL-r10 ,
  bandParametersDL-r10 BandParametersDL-r10
```

ADD information inside “BandparametersUL/DL-r10

Although the method, apparatus and computer program product may be implemented in a variety of different systems, one example of such a system is shown in FIG. 1, which includes a first communication device (e.g., mobile terminal 10) and a second communication device (e.g. mobile terminal 16) that are capable of communication via an access point 12, such as a base station, a Node B, an evolved Node B (eNB), serving cell or other access point, with a network 14 (e.g., a core network). While the network may be configured in accordance with long term evolution (LTE), LTE advanced (LTE-A), and/or the like, other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more cells, including access point 12, each of which may serve a respective coverage area. The serving cell and the neighbor cells could be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

A communication device, such as the mobile terminal 10 (also known as user equipment (UE)), may be in communication with other communication devices or other devices via the access point 12 and, in turn, the network 14. In some cases, the communication device may include an antenna for transmitting signals to and for receiving signals from a serving cell. Alternatively or additionally the mobile terminal 10 be configured for D2D communications and may be in communications with mobile terminal 16.

When referred to herein, a serving cell includes, but is not limited to a primary serving cell (PCell) and other serving cells such as secondary serving cells (SCell) that may be operating on an access point, such as access point 12. A candidate cell, target cell, neighbor cell and/or the like may also be used herein, and that includes a cell that is not currently a serving cell, but may become a serving cell in the future. A PCell, which may be embodied by an access point, generally includes, but is not limited to, a cell that is configured to perform initial establishment procedures, security procedures, system information (SI) acquisition and change monitoring procedures on the broadcast channel (BCCH) or data channel (PDCCH), and paging. The SCell, which may be embodied by a remote radio head (RRH) and is configured to provide additional radio resources to the PCell. In an embodiment, a “primary band” is the band that is indicated by the serving cell as the band of a serving carrier frequency. The secondary band is the band that is indicated by the serving cell as an additional band (e.g. in addition to primary band), that allows a mobile terminal radio frequency that is supported by the secondary band to also camp on the cell.

In some example embodiments, the mobile terminal 10 may be a mobile communication device such as, for example, a mobile telephone, portable digital assistant (PDA), pager, laptop computer, vehicle, machine, special purpose apparatus, or any of numerous other hand held or portable communication devices, computation devices, content generation devices, content consumption devices, or combinations thereof. As such, the mobile terminal 10 may include one or more, processors, such as one or more special purpose processors that may define processing circuitry either alone or in combination with one or more special purpose memories. The processing circuitry may utilize special purpose instructions stored in the memory to cause the mobile terminal 10 to operate in a particular way or execute special purpose functionality when the instructions are executed by the one or more processors. The mobile terminal 10 may also include special purpose communication circuitry and corresponding hardware/software to enable communication with other devices and/or the network 14.

In one embodiment, for example, the mobile terminal 10 and/or the access point 12 may be embodied as or otherwise include an apparatus 20 as generically represented by the block diagram of FIG. 2. While the apparatus 20 may be employed, for example, by a mobile terminal 10 or an access point 12, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other special purpose processing and special purpose management services according to an example embodiment of the present invention. In some embodiments, the apparatus or the processing circuitry may be embodied as a chip or chip set or system in package. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip or a “system in package (SIP).” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal, vehicle, fixed position apparatus, e.g. water meter, electric power meter.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, gesture, camera, a microphone, a speaker, and/or other input/output mechanisms. The apparatus 20 need not always include a user interface. For example, in instances in which the apparatus is embodied as an access point 12, the apparatus may not include a user interface or alternatively user interface is used for special purpose only, e.g. in an emergency case. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry 22, such as between the mobile terminal 10 and the access point 12. In this regard, the communication interface may include, for example, an antenna (or multiple antennas or antenna system) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24 or the memory may be configured to transmit or receive input data at a later time to conserve power. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

FIGS. 3 and 4 are flowcharts illustrating the operations performed by a method, apparatus and computer program product, such as apparatus 20 of FIG. 2 in accordance with some example embodiments of the present invention are illustrated. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other special purpose programmable apparatus (e.g., hardware) to produce a special purpose machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing circuitry 22, e.g., processor, to perform an example embodiment. In some cases, a general purpose computer may be provided with an instance of the processor which performs the algorithm of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included (an example of which is shown in dashed lines in FIG. 3). It should be appreciated that each of the modifications, optional additions or amplifications below may be included with the operations above either alone or in combination with any others among the features described herein.

Referring now to FIG. 3, the operations of a method, apparatus and computer program product are configured to decrease power consumption by a mobile terminal. As shown in operation 302, the apparatus 20 that is embodied, for example, by the mobile terminal 10 may include means, such as the processing circuitry 22, the processor 24, the communications interface 26 or the like, for causing one or more bands operating in a geographical area to be monitored in order to determine an power consumption level for each of the one or more bands in different configurations. In some example embodiments, the mobile terminal 10, may access available frequency bands and their corresponding power consumption level in a memory 28 or on a remote server via the communications interface 26. In some example embodiments, the power consumption for each possible network configuration (e.g. band/bandwidth/data-class combinations) may be specified and/or distributed by a mobile terminal manufacturer. Alternatively network configurations may be ranked in power consumption order.

As shown in operation 304, the apparatus 20 that is embodied, for example, by the mobile terminal 10 may include means, such as the processing circuitry 22, the processor 24 or the like, for determining a characterization of an upcoming communication. In some example embodiments, the characterization comprises one or more transmissions or receptions. For example in LTE systems, a mobile terminal, such as mobile terminal 10, may receive an indication about 4 ms (e.g. 4 subframes) in advance of an upcoming transmission or reception.

As shown in operation 306, the apparatus 20 that is embodied, for example, by the mobile terminal 10 may include means, such as the processing circuitry 22, the processor 24 or the like, for determining a proposed network configuration based on a determined power consumption level of one or more network configurations available in the geographical area and/or the characterization of the upcoming communication. For example, in an instance in which the mobile terminal receives information about an upcoming transmission or reception communication (see operation 302), the mobile terminal 10 may determine, such as by the processing circuitry 22, the processor 24 or the like, the network configuration (e.g. band/bandwidth/data-class) would result in lowest power consumption level. Alternatively or additionally, the network determination may be achieved by cognitive processes or may be stored in the mobile terminal 10 (e.g. memory 28) based on predetermined specifications. In some example alternative embodiments, the mobile terminal 10 may be in communications with a network entity using a first configuration e.g. due to move to other network cell area, however, the mobile terminal 10 may also detect network resources and rank configurations and then propose to the network a new configuration to reduce power consumption.

Alternatively or additionally, the apparatus 20 that is embodied, for example, by the mobile terminal 10 may include means, such as the processing circuitry 22, the processor 24, the communications interface 26 or the like, for determining a proposed network configuration based on a network configuration information stored on a remote server, wherein the remote server comprises at least one proposed network configuration that results in reduced power consumption in a geographical area.

As shown in operation 308 the apparatus 20 that is embodied, for example, by the mobile terminal 10 may include means, such as the processing circuitry 22, the processor 24, the communications interface 26 or the like, for determining current radio condition of the proposed network configuration. As shown in operation 310 the apparatus 20 that is embodied, for example, by the mobile terminal 10 may include means, such as the processing circuitry 22, the processor 24, the communications interface 26 or the like, for determining a current data capability in a time domain and latency of the proposed network configuration. The mobile terminal 10 may determine, based on the band monitoring (e.g. operation 302), whether the radio conditions, data capabilities or the like of a selected band and/or network configuration are above a predetermined level, thus allowing operation on a particular band or network configuration. In an instance in which the radio conditions, data capabilities, latencies or the like of the band are below a predetermined level, then as shown in operation 312 the apparatus 20 that is embodied, for example, by the mobile terminal 10 may include means, such as the processing circuitry 22, the processor 24 or the like, for proposing an alternative network configuration in an instance in which the radio conditions or the data capability in a time domain for the proposed network configuration is below a predetermined threshold.

As shown in operation 314 the apparatus 20 that is embodied, for example, by the mobile terminal 10 may include means, such as the processing circuitry 22, the processor 24, the communications interface 26 or the like, for causing the proposed network configuration or the alternative configuration to be transmitted to a network entity, such as access point 12. In some example embodiments, the apparatus 20 that is embodied, for example, by the mobile terminal 10 may include means, such as the processing circuitry 22, the processor 24, the communications interface 26 or the like, for causing a UE-EUTRA capability information message to be transmitted to access point 12, wherein the message comprises configuration information for the one or more supported network configuration operating in the geographical area.

As shown in operation 316 the apparatus 20 that is embodied, for example, by the mobile terminal 10 may include means, such as the processing circuitry 22, the processor 24, the communications interface 26 or the like, for receiving a confirmation from the network entity, wherein the confirmation indicates that the upcoming communication will be conducted using the proposed network configuration. As shown in operation 318 the apparatus 20 that is embodied, for example, by the mobile terminal 10 may include means, such as the processing circuitry 22, the processor 24, the communications interface 26 or the like, for causing the upcoming communication to be conducted on the proposed network configuration.

Referring now to FIG. 4, the operations of a method, apparatus and computer program product are configured to minimize/decrease power consumption at a mobile terminal by a network entity such as access point 12. As shown in operation 402, the apparatus 20 that is embodied, for example, by the access point 12 may include means, such as the processing circuitry 22, the processor 24, the communications interface 26 or the like, for receiving a proposed network configuration from a mobile terminal, such as mobile terminal 10, wherein the proposed network configuration is based on an power consumption level, ongoing communications and/or an upcoming communication. See for example FIG. 3.

As shown in operation 404, the apparatus 20 that is embodied, for example, by the access point 12 may include means, such as the processing circuitry 22, the processor 24 or the like, for determining whether the proposed network configuration is operable for the upcoming communication. In some example embodiments, a network is operable in an instance in which the radio conditions or the data capability in a time domain for the proposed network configuration is above a predetermined threshold. In some example embodiments, the network entity, such as access point 12, may cause the upcoming communication to be conducted on the preferred network in an instance in which the preferred network is operable. See operation 406. However, in some example embodiments, the network entity, such as access point 12, may determine, such as by using the processing circuitry 22, the processor 24 or the like, an alternative network configuration in an instance in which the preferred network is not operable. See operation 408.

Advantageously, the example systems and methods as described herein may allow for reduced power consumption in mobile terminals without hardware modification. The reduction of power consumption may lead to an increased standby times and/or allow for more applications to concurrently be executing on an example mobile terminal. Additionally, and by way of further example, in a global ecosystem reduced power consumption is possible for all mobile terminals and mobile terminal generation may gain power consumption savings.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
characterizing a communication, wherein the characterization comprises one or more transmissions or receptions;
determining a proposed network configuration based on a determined power consumption level of one or more network configurations available in a geographical area and the characterization of the communication; and
causing the proposed network configuration to be transmitted to a network entity.

2. The method of claim 1, wherein the one or more network configurations comprises at least one of frequency bands, data class, multiple input multiple output class, radio link latency, bandwidth, number of resource blocks, number of receivers, number of transmitters, number of sub carriers, modulations, carrier aggregation combinations, network data load, running applications, multiple concurrent radio communications, or alternate radio access technology that is configured for a reduced power consumption level.

3. The method of claim 1, wherein the communication comprises at least one of an upcoming communication or an ongoing communication.

4. A method according to claim 1 further comprising:
causing one or more bands operating in a geographical area to be monitored in order to determine a power consumption level for each of the one or more bands.

5. A method according to claim 1 further comprising:
receiving a confirmation from the network entity, wherein the confirmation indicates that the communication will be conducted using the proposed network configuration; and
causing the communication to be conducted on the proposed network configuration.

6. A method according to claim 1, further comprising:
determining current radio conditions of the proposed network configuration;
determining a current data capability in time domain of the proposed network configuration; and
selecting an alternative network configuration in an instance in which the current radio conditions or the current data capability for the proposed network configuration is below a predetermined threshold.

7. A method according to claim 1, further comprising:
causing a User Equipment-Evolved Universal Terrestrial Radio Access (UE-EUTRA) capability information message to be transmitted, wherein the message comprises configuration information for one or more supported network configurations operating in the geographical area.

8. A method according to claim 1, further comprising:
determining the proposed network configuration based on network configuration information stored on a remote server.

9. A method according to claim 1, further comprising:
causing the communication to be shifted to a future time domain moment based on a determined power consumption level for the future time domain moment.

10. An apparatus comprising:
at least one processor; and
at least one memory including computer program code, the at least one memory and the computer program code configured to, with the at least one processor, cause the apparatus to at least:
characterize a communication, wherein the characterization comprises one or more transmissions or receptions;
determine a proposed network configuration based on a determined power consumption level of one or more network configurations available in a geographical area and the characterization of the communication; and
cause the proposed network configuration to be transmitted to a network entity.

11. An apparatus of claim 10 wherein the one or more network configurations comprises at least one of frequency bands, data class, multiple input multiple output class, radio link latency, bandwidth, number of resource blocks, number of receivers, number of transmitters, number of sub carriers, modulations, carrier aggregation combinations, network data load, running applications, multiple concurrent radio communications, or alternate radio access technology that is configured for a reduced power consumption level.

12. An apparatus according to claim 10 wherein the at least one memory including the computer program code is further configured to, with the at least one processor, cause the apparatus to:
cause one or more bands operating in a geographical area to be monitored in order to determine a power consumption level for each of the one or more bands.

13. An apparatus according to claim 10 wherein the at least one memory including the computer program code is further configured to, with the at least one processor, cause the apparatus to:
receive a confirmation from the network entity, wherein the confirmation indicates that the communication will be conducted using the proposed network configuration; and
cause the communication to be conducted on the proposed network configuration.

14. An apparatus according to claim 10, wherein the at least one memory including the computer program code is further configured to, with the at least one processor, cause the apparatus to:
determine current radio conditions of the proposed network configuration;
determine a current data capability of the proposed network configuration; and
select an alternative network configuration in an instance in which the current radio conditions or the current data capability for the proposed network configuration is below a predetermined threshold.

15. An apparatus according to claim 10, wherein the at least one memory including the computer program code is further configured to, with the at least one processor, cause the apparatus to:
cause a User Equipment-Evolved Universal Terrestrial Radio Access (UE-EUTRA) capability information message to be transmitted, wherein the message comprises configuration information for one or more supported network configurations operating in the geographical area.

16. An apparatus according to claim 10, wherein the at least one memory including the computer program code is further configured to, with the at least one processor, cause the apparatus to:
determine the proposed network configuration based on network configuration information stored on a remote server.

17. An apparatus according to claim 10, wherein the at least one memory including the computer program code is further configured to, with the at least one processor, cause the apparatus to:
cause the communication to be shifted to a future time domain moment based on a determined power consumption level for the future time domain moment.

18. A computer program product comprising:
at least one computer readable non-transitory memory medium having program code stored thereon, the program code which when executed by an apparatus cause the apparatus at least to:
characterize a communication, wherein the characterization comprises one or more transmissions or receptions;
determine a proposed network configuration based on a determined power consumption level of one or more network configurations available in a geographical area and the characterization of the communication; and
cause the proposed network configuration to be transmitted to a network entity.

19. A computer program product according to claim 18 further comprising program code instructions configured to:
cause one or more bands operating in a geographical area to be monitored in order to determine a power consumption level for each of the one or more bands.

20. A computer program product according to claim 18 further comprising program code instructions configured to:
receive a confirmation from the network entity, wherein the confirmation indicates that the communication will be conducted using the proposed network configuration; and
cause the communication to be conducted on the proposed network configuration.
